(19) United States
(12) Patent Application Publication
(10) Pub. No.: US 2009/0000256 A1
(43) Pub. Date: Jan. 1, 2009

(54) Filter Bag for Filtering Fine Particles from a Gas

(76) Inventors: Juergen Hesse, Steinenbronn (DE); Thomas Palaver, Filderstadt (DE); Steffen Tiede, Herrenberg (DE)

Correspondence Address: MICHAEL J. STRIKER, 103 EAST NECK ROAD, HUNTINGTON, NY, 11743, US

(21) Appl. No.: 12/159,290

(22) PCT Filed: Aug. 1, 2007
(86) PCT No.: PCT/EP2007/057943

§ 371 Date: Jun. 26, 2008

(30) Foreign Application Priority Data
Aug. 16, 2006 (DE) 102006038440.7

(51) Int. Cl. B01D 46/00

(52) U.S. Cl. 55/382

(57) ABSTRACT

The invention relates to a filter bag for filtering fine particles from a gas, having a filter coating at least of a certain coating thickness, and at least one filter layer of a certain layer thickness that disposed downstream of the filter coating in the direction of the gas flow. The invention is based on the task of providing a filter bag having a low tendency to clog, thus improving the service life of the dust filter bag, particularly upon the filtering of fine dusts. The task is solved in that the coating thickness of the filter coating (1) is essentially larger than the coating thickness of the filter layer (3, 4) disposed downstream.

### PRIOR ART

The invention relates to a filter bag for filtering fine particles from a gas, which filter bag is composed of at least one filter layer of a particular layer thickness and at least one filter ply of a particular layer thickness, the latter of which is situated downstream of the filter layer in the flow direction of the gas.

Filter bags of this kind are in particular used as dust filter bags in stationary or mobile dust removal units in household and industrial applications or in air handling systems.

The requirements as to the efficiency of these dust filter bags have risen significantly in the last few years. As hygiene and health awareness increases, considerable importance is now attached to fine particle removal. Modern dust filters are therefore expected to have a high separation efficiency for even extremely fine dust such as the dust from dust mites or tobacco dust contained in household dust. At the same time, the air resistance of the filter should be kept as low as possible despite its high dust capturing capacity in order to assure a high performance of the dust removal units over the long term and to avoid frequent filter changes. In order to be able to withstand the pressure increase due to the increasing air resistance of the filter in the filter bag, it is also necessary to assure the mechanical stability of the dust filter bag so that it does not tear. Addressing this complex array of requirements, new filter materials and filter constructions are known from the prior art such as two- or three-ply filter bags with an upstream side filter layer, an optional subsequent intermediate layer, and a downstream side substrate ply or support ply. The individual plies of the multi-ply dust filter bag are very thin-layered and are embodied with virtually the same layer thickness as one another in order to produce a high dust capturing volume in a dust catching receptacle of the dust removal unit. These thin-layered filters are therefore also referred to as surface-type filters. The removal of extremely fine particles with these conventional multi-ply dust filter bags disadvantageously results either in an unsatisfactory separating action or a very rapid clogging of the filter with an accompanying powerful increase in the filter resistance that significantly reduces the suction power and necessitates a premature replacement of the dust filter bag. Extremely fine particles such as sanding dust from gypsum quickly clog the pores of the filter material until it becomes unusable despite the fact that the dust filter bag appears to be empty.

The object of the invention, therefore, is to create a filter bag with a low propensity for clogging and therefore to extend the service life of the dust filter bag particularly when filtering fine dust.

### DISCLOSURE OF THE INVENTION

The object is attained according to the invention by means of a dust filter bag in which in the layer thickness of the filter layer is a significantly greater than the layer thickness of the filter ply situated downstream of it. Through a more voluminous embodiment of the filter layer, it is possible to capture more particles than with a less voluminous filter layer. Previously, the increase in the filter resistance and reduction of the filling volume available for dust capturing that supposedly accompanied a significantly thicker filter layer were thought to be at odds with the above-mentioned design concept. But the fine dust filter layers that have become known in the last few years are distinguished by a low mass per unit area and a high air permeability; the “thickening” of the filter material does not lead to any significant increase in the air resistance. It has also surprisingly turned out that despite the significantly greater volume that the filter material of the filter layer occupies in the filter bag according to the invention in comparison to the filter material in conventional dust filter bags, the particle capturing capacity is several times the particle capturing capacity of the conventional dust filter bags described in the prior art, without having to accept considerable losses in suction power and without the occurrence of the clogging phenomenon. This effect is demonstrated in a particularly pronounced fashion with very fine dust particles. In the voluminous filter layer, the speed of the dust particles from the volumetric flow of exhaust air is sufficiently braked so that the dust particles can be favorably distributed and captured in the voluminous filter layer and to the greatest extent possible, do not come into contact with the downstream filter plies that would otherwise be at risk of becoming clogged. The dust filter bag according to the invention, despite its multi-ply design, constitutes a novel deep-bed filter that significantly increases the service life of the dust filter bag. The layer thickness of the filter layer according to the invention can be composed of a plurality of filter layers. In this application, the term “layer thickness” is understood in particular to mean the sum of the thicknesses of the individual filter layers.

The greater the layer thickness of the filter layer, the more striking the above-mentioned advantages become. In one advantageous embodiment, therefore, the layer thickness of the filter layer is 5 times the layer thickness of the downstream filter ply.

If the layer thickness of the filter layer is 15 to 20 times the layer thickness of the downstream filter ply, then this achieves an optimal volume of the filter material of the filter layer in the dust filter bag for an effective filtration of extremely fine particles with only a slightly higher flow resistance of the filter bag. It is thus possible to significantly extend the service life of a dust filter bag with a simultaneously insignificant rise in pressure loss. In particular, the layer thickness of the filter layer can be 3 mm or more.

It is also preferable for the filter bag to have a dust filling chamber that is entirely filled with the filter layer. The inner chamber of the filter bag is therefore filled with filter material; due to the softness of the filter material, there is sufficient dust capturing space.

The downstream filter ply performs additional filtering functions. In a preferred embodiment, the downstream filter ply is embodied as a support ply. The supporting action of the support ply, together with a sufficient tear resistance, gives the filter bag the required stability so that it withstands the mechanical load in the air flow without tearing. In particular, the filter material of the filter layer, which is encumbered with a low inherent stability due to its low mass per unit area, can withstand the mechanical loads in a dimensionally stable fashion by means of the support ply, particularly during the pressure increase in the dust filter bag, and the usually denser material structure of the support ply does not become clogged thanks to the advantageous action of the filter layer.

In another embodiment, a plurality of downstream filter plies is provided; according to the main claim, in each of the filter plies, the layer thickness of the filter layer is significantly greater than the layer thickness of the subsequent filter plies. The main focus is a filter layer that is voluminous in comparison to the downstream filter plies; the advantageous property of the filter layer is promoted by the function of the downstream filter plies. While the filter layer is kept dimensionally stable by a support ply, a favorable combination, for example, of filter plies with filter materials of different filtering properties—e.g. with regard to the average fiber diameter, the electrostatic charge, the mass per unit area, and the air permeability coefficient—increases the overall filter performance and therefore the service life of the filter bag according to the invention.

If the filter layer is placed essentially loosely against the downstream filter ply, then the flow of gas through the dust filter bag can easily move the filter layer and set it into vibration, causing a particle layer that has accumulated on the surface of the filter layer to be shaken off into the interior of the filter bag so that it is prevented to the greatest extent possible from hindering the deep-bed filtering property of the filter layer according to the invention. The dimensional flexibility of the filter layer is limited by the downstream filter ply against which the filter layer rests due to the delivery pressure of the air flow so that the filter layer is not subjected to a tear-inducing load.

In a preferred embodiment, the filter layer is composed of a melt-blown nonwoven. Melt-blown nonwoven is an extremely fine fibrous nonwoven that is manufactured out of a thermoplastic polymer by means of a melt-blowing method and has a particularly high air permeability coefficient with a low mass per unit area. It also has an outstanding separation efficiency for fine dust while also having a low flow resistance so that it is particularly well-suited to a voluminous filter layer as defined by the present invention. In addition, this melt-blown nonwoven has a very low rigidity so that it can be easily inserted into the filter bag and is able to adapt to any desired external shape of the filter bag.

### BRIEF DESCRIPTION OF THE DRAWINGS

The filter bag according to the invention will be explained in greater detail below in conjunction with an exemplary embodiment. In the associated drawings,

FIG. 1 shows a schematic sectional depiction of a layer structure of a dust filter bag and

FIG. 2 shows a section through the dust filter bag.

### EXEMPLARY EMBODIMENT(S) OF THE INVENTION

The application possibilities of the filter bag according to the invention relate not only to dust filter bags for the dust receptacles of compact household vacuum cleaners with a dust receptacle volume of 1 to 5 liters, but also to large dust bags, e.g. for mobile or stationary industrial vacuum cleaners (wet/dry vacuum cleaners) with high flow rates that have dust receptacle volumes of 50 liters and more. It is also possible to use the invention as an externally mounted dust bag for a power tool with an integrated exhaust unit, e.g. a drill or sander. A dust filter bag of an industrial vacuum cleaner is described below by way of example.

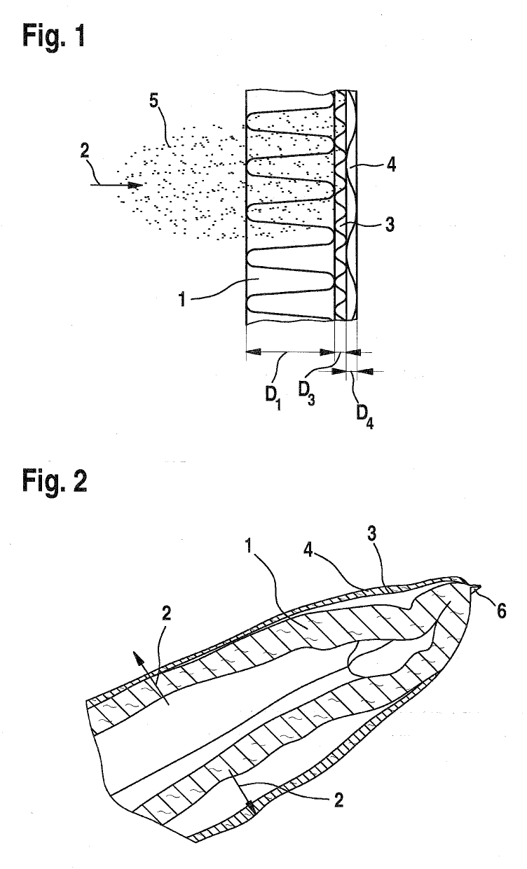

The layer structure of the dust filter bag according to the invention shown in FIG. 1 is composed of a voluminous filter layer 1 made a melt-blown nonwoven, an intermediate layer 3 that is situated downstream of the filter layer 1 in the flow direction 2 of the exhaust flow, and a support ply 4 situated further downstream in the flow direction 2 of the exhaust flow. In this case, the layer thickness D₁ of the filter layer 1 is significantly greater than the layer thickness D₃ of the intermediate layer 3 and the layer thickness D₄ of the support ply 4. As is clear from the sectional depiction in FIG. 2, in the dust filter bag according to the exemplary embodiment, the layer thickness D₁ of the filter layer 1 is approximately 18 times greater than the layer thickness D₃ of the intermediate layer 3 and the layer thickness D₄ of the support ply 4. The extreme thickness of the filter layer 1 composed of melt-blown nonwoven is therefore very voluminous, but nevertheless has a high air permeability. With the filter volume thus attained, it is possible to capture several times the number of particles 5 that it was originally possible to capture with dust filter bags according to the prior art. For example, during vacuum removal of gypsum particles 5 when performing sanding work on gypsum, a dust filter bag according to the invention with a filling volume of 3 liters has a service life 10 times longer than that of conventional filters known from the prior art. The capturing capacity of the dust filter bag rises from approximately 50 g to as much as 500 g of sanding dust. With the longer service life of the dust filter bag, it is possible to extend the uninterrupted sanding time from 3 minutes to over 30 minutes.

The gypsum particles 5 supplied with the volumetric flow of air are braked and captured in the voluminous filter layer 1, which prevents the gypsum particles 5 from striking the subsequent filter layers, in particular the more densely structured support ply 4. As a result, the intermediate layer 3 and support ply 4 are protected from clogging while the flow resistance as a whole rises only slightly so that there is only a negligible reduction in suction power.

With its supporting action, the external support ply 4 provides the required dimensional stability and tear resistance of the dust filter bag according to the invention equipped with a very soft and voluminous filter layer 1; as is clear in the exemplary embodiment in FIG. 2, the support ply 4 can also be attached to the intermediate layer 3. It is also clear that the filter layer 1 is placed loosely against the intermediate layer 3 and is attached to the filter layers 3, 4 only at the folded edges 6, thus also achieving the above-described advantageous mobility of the filter layer 1 in the dust filter bag.

What is claimed is:

1. A filter bag for filtering fine particles from a gas, which filter bag is composed of at least one filter layer of a particular layer thickness and at least one filter ply of a particular layer thickness, the latter of which is situated downstream of the filter layer in the flow direction of the gas,
wherein the layer thickness of the filter layer (1) is significantly greater than the layer thickness of the downstream filter ply (3, 4).

2. The filter bag as recited in claim 1,
wherein the layer thickness of the filter layer (1) is at least 5 times the layer thickness of the downstream filter ply (3, 4).

3. The filter bag as recited in claim 1,
wherein the layer thickness of the filter layer (1) is 15 to 20 times the layer thickness of the downstream filter ply (3, 4).

4. The filter bag as recited in claim 1,
wherein the layer thickness of the filter layer (1) is 3 mm or more.

5. The filter bag as recited in claim 1,
wherein the filter bag has a dust filling chamber that is entirely filled with the filter layer.

6. The filter bag as recited in claim 1,
wherein the downstream filter ply (3, 4) is embodied in the form of a support ply (4).

7. The filter bag as recited in claim 1,
wherein a plurality of filter plies (3, 4) are provided.

8. The filter bag as recited in claim 1,
wherein the filter layer (1) is placed essentially loosely against the downstream filter ply (3, 4).

9. The filter bag as recited in claim 1,
wherein the filter layer (1) is composed of melt-blown nonwoven.
